(19) United States
(12) Patent Application Publication
(10) Pub. No.: US 2002/0152193 A1
(43) Pub. Date: Oct. 17, 2002

(54) System and method for displaying images

(76) Inventors: Robert S. Thompson, Loveland, CO (US); John Mark Carleton, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/834,367

(22) Filed: Apr. 13, 2001

(51) Int. Cl. G06F 7/00

(52) U.S. Cl. 707/1

(57) ABSTRACT

The present disclosure relates to a method for displaying images, comprising the steps of receiving image location information provided by a user, retrieving an image through use of the image location information, and displaying the retrieved image with a display medium. With this method, images can be retrieved from substantially any location accessible over a network such as the Internet. Accordingly, the user need not be limited to accessing images from one particular source such as a particular vendor's web server.

### FIELD OF THE INVENTION

The present disclosure relates to a system and method for displaying images. More particularly, the disclosure relates to a system and method for retrieving images accessible via a network, such as the Internet, and displaying the images to a user.

### BACKGROUND OF THE INVENTION

In recent years, it has become popular to store images such as photographs electronically. With such electronic storage, the images can be more easily shared with others, for instance via email. In addition, electronic storage of images provides various viewing options to the user that are not available with conventional photographs. For instance, images can be stored on a hard drive of the user's desktop computer and accessed for display to the user in a slide show format that, for example, can be used as a screen saver.

The advent of the Internet and particularly the World Wide Web has further increased image sharing and viewing options. For instance, a user can post images to a web site that can be accessed by anyone who has the site address and access to the Internet. Recently, independent display devices have been introduced in the market that are capable of retrieving images from a web server and displaying the images to the device user. One such device is configured as a picture frame that includes a display screen on which the images can be displayed. Such devices permit the user to view images retrieved from a web server without having to download the images to a hard drive. Indeed, the user need not even have a desktop computer if the device is capable of retrieving images in this manner.

Thus far, the display devices that have been introduced are configured to retrieve images from a particular location, e.g., a web server of the device vendor. Normally, access to the vendor web server is provided only in exchange for a fee. With this configuration, the device user is limited in terms of the sources he or she can access for image retrieval. In particular, the user cannot retrieve images from the many other web servers (and therefore web sites and web pages) accessible over the Internet. Moreover, if the user does not wish to subscribe to a pay service, no retrieval can be had at all.

From the foregoing, it can be appreciated that it would be desirable to have a system and method for displaying images that is capable of retrieving images across a network but which avoids the limitations identified above.

### SUMMARY OF THE INVENTION

The present disclosure relates to a method for displaying images, comprising the steps of receiving image location information provided by a user, retrieving an image through use of the image location information, and displaying the retrieved image with a display medium.

The present disclosure also relates to a system for displaying images. In one embodiment, the system comprises means for receiving image location information provided by a user, means for retrieving an image through use of the image location information, and means for displaying the retrieved image with a display medium. In another embodiment, the system comprises logic configured to receive image location information input from a user, logic configured to retrieve an image based upon the image location information, and logic configured to display the image on a display medium.

With the method and system, images can be retrieved from substantially any location accessible over a network such as the Internet. Accordingly, the user need not be limited to accessing images from one particular source such as a particular vendor's web server.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of a system for displaying images.

FIG. 2 is a schematic view of a computing device shown in FIG. 1.

FIG. 3 is a schematic view of a display device shown in FIG. 1.

FIG. 4 is a flow diagram that illustrates operation of a display module shown in FIG. 2.

FIG. 5 is a flow diagram that illustrates operation of a display module shown in FIG. 3.

FIG. 6 is a flow diagram that illustrates a method for displaying images.

### DETAILED DESCRIPTION

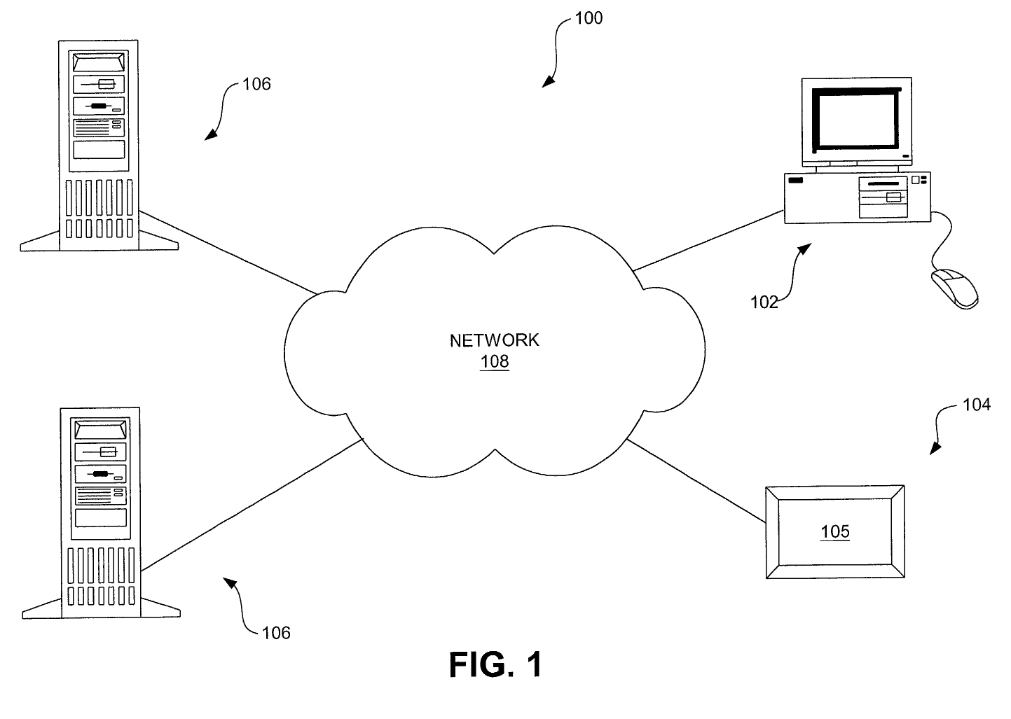

Referring now in more detail to the drawings, in which like numerals indicate corresponding parts throughout the several views, FIG. 1 illustrates a system 100 for displaying images. As indicated in this figure, the system 100 can comprise a computing device 102, an independent display device 104, and one or more servers 106. Each of these components is connected to a network 108 that typically comprises the Internet. In a preferred arrangement, the computing device 102 comprises a desktop computer, the display device 104 comprises a digital picture frame that includes a display screen 105, and the servers 106 comprise web servers. Although only two servers 106 are shown in FIG. 1, it is to be understood that these servers are merely representative of the multitudes of servers accessible over the network 108. As is discussed in detail below, the computing device 102 can be used to display images retrieved from one or more sources such as servers 106. In addition, the computing device 102 can be used to configure the operation of the display device 104 such that the display device can similarly retrieve images from a desired source.

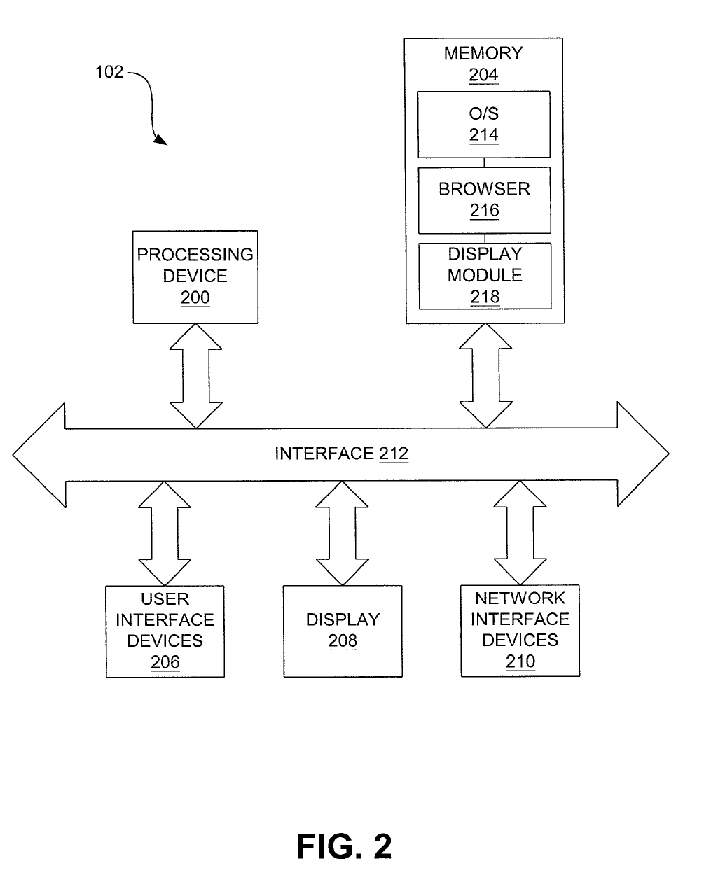

FIG. 2 is a schematic view illustrating an example architecture for the computing device 102 shown in FIG. 1. As indicated in FIG. 2, the computing device 102 comprises a processing device 200, memory 204, user interface devices 206, a display 208, and network interface devices 210. Each of these components is connected to an interface 212 that, by way of example, comprises one or more internal buses. In addition, the interface 212 can include an external bus used to connect to other devices. The local interface 212 may have additional elements, which are omitted for simplicity, such as controllers, buffers (caches), drivers, repeaters, and receivers, to enable communications. Furthermore, the interface 212 may include address, control, and/or data connections to enable appropriate communications among the aforementioned components.

The processing device 200 comprises hardware for executing software and/or firmware that is stored in memory 204. The processing device 200 can include any custom made or commercially available processor, a central processing unit (CPU) or an auxiliary processor among several processors associated with the computing device 102, a semiconductor based microprocessor, (in the form of a microchip), or a macroprocessor. The memory 204 can include any one of combination of volatile memory elements (e.g., random access memory (RAM, such as DRAM, SRAM, etc.)) and nonvolatile memory elements (e.g., ROM, hard drive, tape, CDROM, etc.). Moreover, the memory 204 can incorporate electronic, magnetic, optical, and/or other types of storage media. Note that the memory 204 can have a distributed architecture, where various components are situated remote from one another, but accessible by the processing device 200.

The user interface devices 206 typically comprise those normally used in conjunction with a desktop computer such as a keyboard, mouse, etc. As indicated in FIG. 1, the display 208 typically comprises a monitor. The network interface devices 210 comprise the hardware with which the computing device 102 transmits and receives information over the network 108. By way of example, the network interface devices 210 can include components that communicate both inputs and outputs, for instance, a modulator/demodulator (e.g., analog, digital subscriber line (DSL), or cable modem), a radio frequency (RF) or other transceiver, a telephonic interface, a bridge, a router, etc.

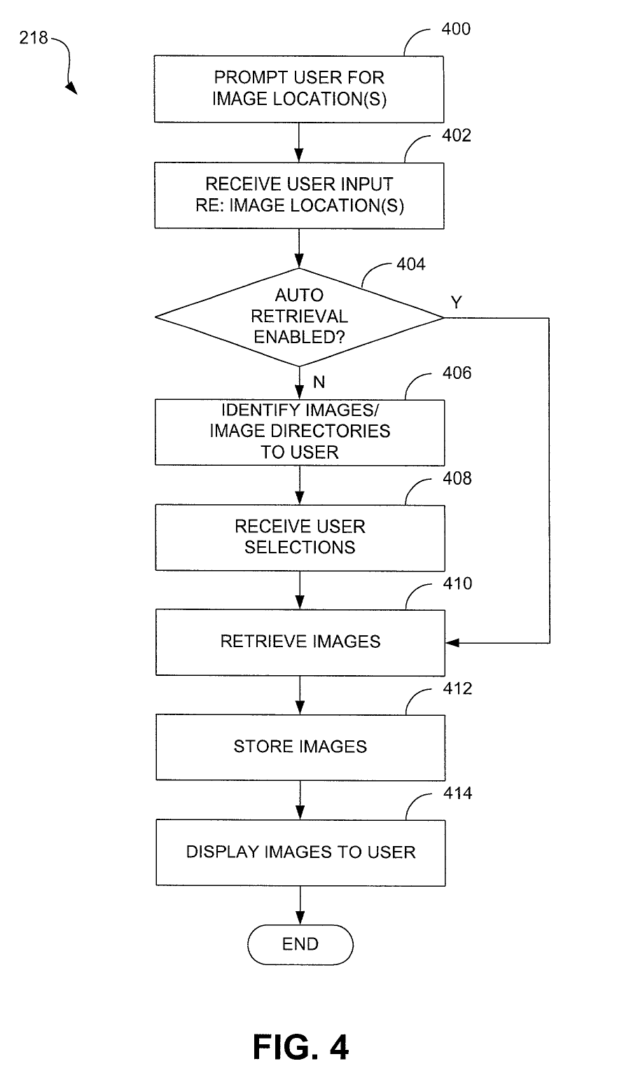

As indicated in FIG. 2, the memory 204 comprises various software programs. In particular, the memory 204 includes an operating system 214, a browser 216, and a display module 218. The operating system 214 controls the execution of other software, such as the browser and display modules 216 and 218, and provides scheduling, input-output control, file and data management, memory management, and communication control and related services. The browser 216 comprises one or more applications with which the user can access the network 108 (e.g., Internet) and, more particularly, the World Wide Web. Examples of suitable web browsers include Internet Explorer™ from Microsoft and Netscape Navigator™ from Netscape. The display module 218 is adapted to retrieve images from the network 108 and display them to the user with the display 208. The operation of the display module 218 is discussed in detail below in relation to FIG. 4.

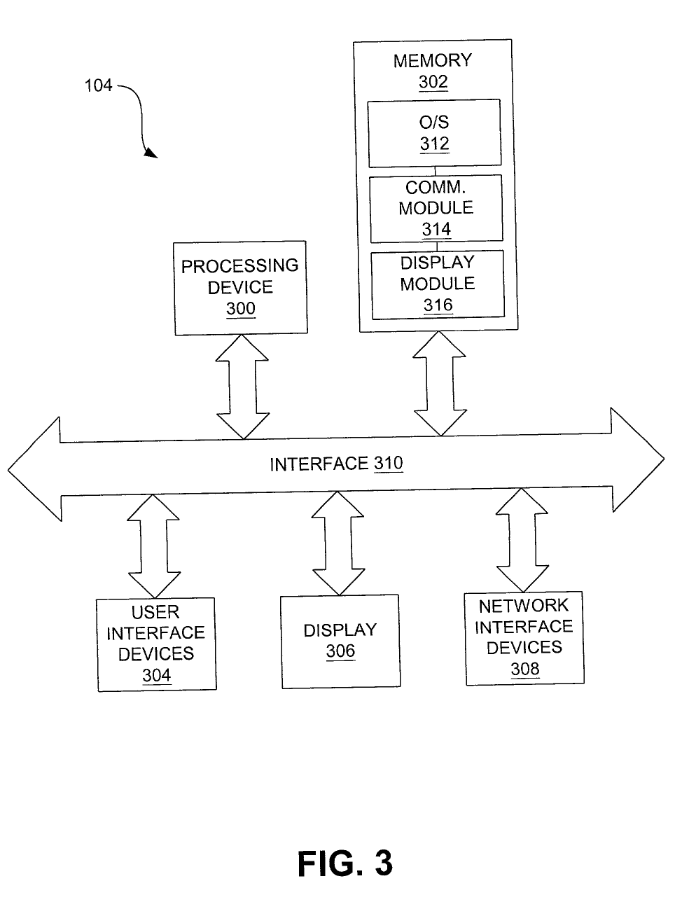

FIG. 3 is a schematic view illustrating an example architecture for the display device 104 shown in FIG. 1. As indicated in FIG. 3, the display device 104 comprises a processing device 300, memory 302, user interface devices 304, a display 306, network interface devices 308, and an interface 310 to which each of the other components electrically connects. In addition, the interface 310 can comprise an external bus used to connect the display devices with other devices. The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the display device 104. The user interface devices 304 typically comprise interface tools with which the device settings can be changed and through which the user can communicate commands to the display device 104. By way of example, the interface devices 304 can comprise one or more function keys with which the operation of the display device 104 can be controlled and a retrieve key with which the display device can be commanded to retrieve images.

The display 306 normally comprises a flat panel liquid crystal display (LCD), such as display screen 105 shown in FIG. 1, with which the retrieved images are shown to the user. In some embodiments, the display 306 can comprise a touch-sensitive display such that commands can be entered by the user via the display. As with the network interface devices 216 of the computing device 102, the network interface devices 308 are adapted to facilitate communications across the network 106 (e.g., Internet) and therefore can comprise a modem or other data transmitting/receiving device. In particular, the network interface devices 216 are adapted to retrieve images stored at designated locations on the network 108 such as a web server 106.

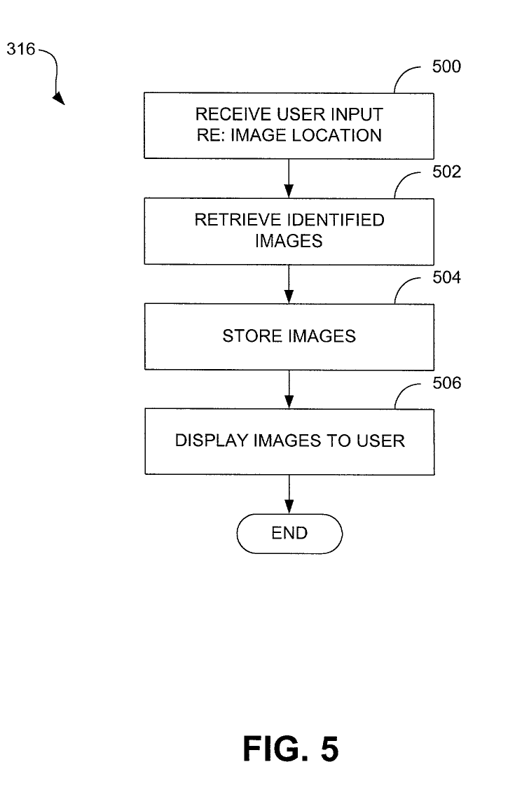

The memory 302 includes an operating system 312, a communications module 314, and a display module 316. The operating system 312 contains the various commands used to control the general operation of the display device 104. The communications module 314 comprises software and/or firmware that is adapted to, in conjunction with the network interface devices 308, facilitate communications over the network 108 such that images can be retrieved via the network. The display module 316 comprises software and/or firmware that is adapted to control the retrieval of such images and is described in detail in relation to FIG. 5.

Various software and/or firmware modules have been described herein. It is to be understood that these modules can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These modules can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium could even be paper or another suitable medium upon which a program is printed, as the program can be electronically captured, via for instance optical scanning of the paper or other medium, then compiled, interpreted or otherwise processed in a suitable manner if necessary, and then stored in a computer memory.

FIG. 4 illustrates operation of the display module 218 of the computing device 102. The module 218 is first activated from the computing device 102 in conventional fashion as by selecting an icon from the computing device display 208. Once the module 218 is activated, the user can be prompted by an application of the display module 218 to enter an image location, as indicated in block 400. The image location typically comprises a web site or web page supported by a web server 106 that stores the images, as well as other attributes of the web site or page. The web site or web page can be configured as a repository for the images to be displayed. Prior to designating the location or locations, the user can upload the various images that user wishes to be displayed to the web site or web page in the conventional manner such that all of the images are directly accessible or located under one or more image directories. The images can be formatted according to various protocols including joint photographic experts group (JPEG) format, tagged image file format (TIFF), graphics interchange format (GIF), etc. By way of example, the user can enter the address of the web site or web page by entering a uniform resource locator (URL) of the web site or web page. Optionally, the user can enter two or more addresses such that images can be drawn from two or more web sites and/or web pages that contain images.

The image location or locations are received by the display module 218, as indicated in block 402. At this point, it is determined whether an automatic retrieval function is enabled, as indicated at decision element 404. If so, flow continues to block 410 as discussed below. If the automatic retrieval function is not enabled, flow continues to block 406 at which the display module 218 accesses the image location (e.g., web site or web page) identified by the user. Once this image location has been accessed, the display module 218 determines the contents of the location and identifies these contents to the user, as indicated in block 406. Specifically, the display module 218 identifies all image files that can be displayed to the user, as well as any image directories associated with the location. In one embodiment, the image files and directories can be identified by title to the user. Alternatively, the user can be presented with pictorial representations of the images, for instance, thumbnail images. Where the image location includes associated image directories, the user can optionally command the display module 218 to display the contents of any selected directory to permit the user to individually select images for display from the directory.

Although the user typically identifies the addresses of web sites or web pages, it is to be understood that substantially any path that leads to an image or images can be specified by the user. Such a path can, for example, comprise a specific URL for the image, or an image tag of a hypertext mark-up language (HTML) file. Regardless of the address entered by the user, the display module 218 will determine the image files associated with the location and present them to the user as options for display. In this manner, the user is provided with the flexibility being able to retrieve substantially any image file accessible via the network 108 for later viewing. To simplify the selection process, the display module 218 can be configured, for instance by user input, to present only certain types of files to the user for selection. For example, the display module 218 can be configured to only present the user with the option to display high resolution image files in that low resolution files are not as suitable for display. Similarly, the display module 218 can be configured to only present image files of a particular image format (e.g., JEP).

The user selections are received by the display module 218 as indicated in block 408. At this point, the display module 218 can retrieve the selected images, as indicated in block 410. Where automatic retrieval is enabled, the display module automatically selects all suitable image files from the identified location or locations for display. Therefore, the automatic retrieval function is well-suited for situations in which the image location is a mere repository for images. Where the computing device is connected to an ordinary telephone line, the display module 218 can be configured so as to periodically (e.g., daily) retrieve image files thereafter at an off-peak time, such as after midnight, to minimize disruption. Depending upon the number of images being downloaded, the downloading process normally only requires a few minutes of line time. Alternatively, where the computing device 102 is connected to a high speed line such as a DSL or cable line, retrieval can occur at frequent intervals (e.g., every few minutes) such that the images are updated more quickly. Once the images are retrieved, they are stored by the display module 218, as indicated in block 412. By way of example, the images can be “permanently” stored in a database (not shown) of the memory 204. Alternatively, where the computing device 102 is connected to a high speed line, the images can be temporarily cached within the memory 204 and replaced with a new image each time the display module 218 retrieves a new image. In such an arrangement, the display module 218 is configured to retrieve images one at a time such that no images are stored for longer than is necessary to display the image.

Once the image or images are stored, they can be displayed to the user, as indicated in block 414. By way of example, the images can be presented to the user in a slide show format in which each selected image is displayed to the user for a predetermined duration of time (e.g., several seconds). As known in the art, this format is well-suited for use as a screen saver that is initiated after a period of non-use of the computing device 102. However, unlike conventional screen savers, the user can access the slide show of images from substantially any computing device that includes the display module 218. In addition, the user need not download the images to a computing device hard drive. Therefore, the user can view images from remote computers and further permit others (e.g., relatives) to access the images, if desired, by providing them with an address to the image locations.

As described above, the independent display device 104 is also provided with a display module 316 that operates in similar manner to the display module 218. In one embodiment, the display module 316 can be used to input addresses that identify image locations. Therefore, the display module 316 can prompt the user to select the various image files (or directories) associated with the input addresses. Such selections can, for instance, be entered by the user via the display screen 105 where the screen is configured as a touch-sensitive screen. In such an arrangement, the various available selections can be presented to the user with a graphical user interface (GUI) and the user can select them by pressing on screen “buttons” displayed on the display screen 105. Alternatively, the user can plug a keyboard (not shown) into the device 104 to interface with the device as is done with desk top computers. In a preferred embodiment, however, such functionality is not provided to both maintain the simplicity of the display device 104 and its use, as well as to keep its cost low. Therefore, the display device 104 is preferably used only to retrieve and display the desired images.

FIG. 5 illustrates the preferred operation of the display module 316 of the display device 104. As indicated in block 500, the image locations are received by the display module 316 as by the display module 218 of the computing device 102. However, in that the display device 104 preferably has fewer user interface elements than the computing device 102, these locations are typically input by the user separate from the device. By way of example, the locations can be input by the user with a desk top computer, such as computing device 102 shown in FIG. 1, by accessing a web site maintained on a web server 106 that is configured to transmit image locations to the display device 104. Such a web site can be maintained by the device vendor or substantially any another entity. To configure the display device 102, in this manner, the user identifies the address of the device (e.g., a URL), and further identifies the addresses or other paths relevant to the image locations. Accordingly, all locations described above can be input by the user at the web site. Once these locations are input, they are transmitted to the display device 104 so that the device can retrieve the images. In another arrangement, the computing device 102 is directly connected to the display device 104 (e.g., via an external bus), and the image locations directly transmitted to the display device. Regardless, images can be retrieved from substantially any web site or web page accessible over the Internet. Accordingly, the user need not be limited to accessing images from one particular source such as the device vendor's web server.

After the image location information has been transmitted to the display device 104, this information is received by the display module 316, as indicated in block 500. Next, the display module 316 can retrieve the images, as indicated in block 502, in the same manner as describe above. By way of example, the initial retrieval can be initiated by the user by selecting the aforementioned retrieve button. Once the images are retrieved, they are stored by the display module 316, as indicated in block 504. Again, the images can be “permanently” stored in a database or temporarily cached and replaced with a new image each time the display module 316 retrieves an image. Once the images are stored, they can be displayed to the user, as indicated in block 506. By way of example, the images can be presented to the user via the display screen 105 in a slide show format in which each selected image is displayed to the user for a predetermined duration of time (e.g., several seconds). Alternatively, a particular image can be displayed continuously just as if it were a conventional framed photograph. Preferably, the user can select which of these functionalities the user desires with the function keys of the user interface devices 304. In a further arrangement, the images can be transmitted for display to a further display device such as a television. In such an arrangement, connection between the display device and the television can be made via an external bus of the display device.

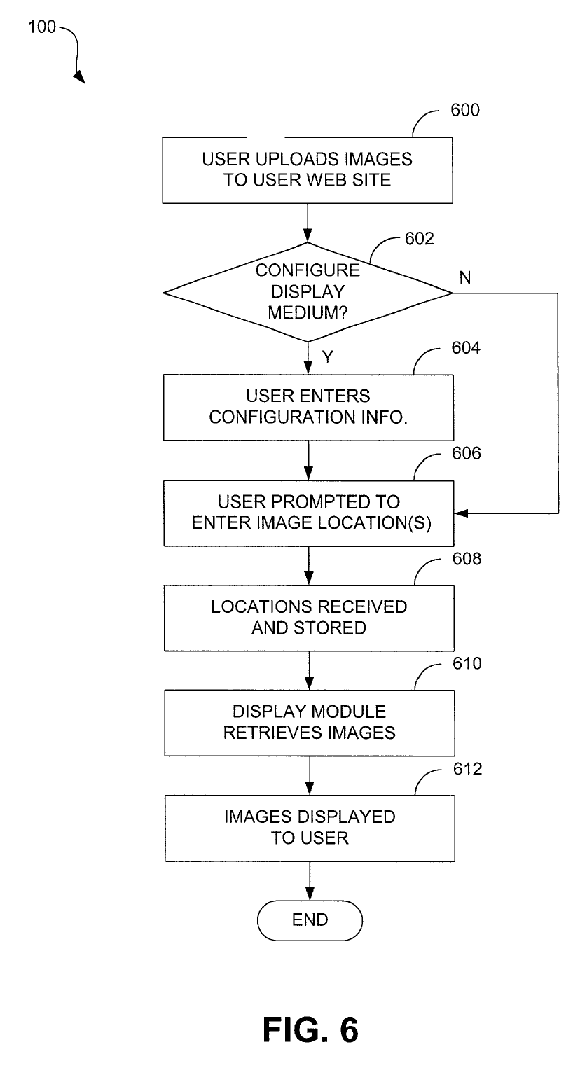

FIG. 6 illustrates an example method for displaying images. As indicated in this figure, the user can first upload images to a web site that he or she maintains, as identified in block 600. As indicated in decision element 602, the user can determine whether or not the user would like to configure the display medium (e.g., computing device 102 or display device 104). If not, flow continues directly to block 606 described below. If the user does wish to configure the display medium, flow continues to block 604. Where the display medium comprises the computing device 102, such configuration may not be necessary in that, due to the provision of the display module 218 and the user interface devices 206, such configuration can be made with an application running on the computing device as described above. If desired, however, such configuration can entered with the web site. This configuration can comprise, for example, identification of the display scheme (e.g., single image or slide show) and the frequency with which the display module 218 will retrieve images (i.e., the update frequency). Where the display medium comprises the display device 104, configuration can further include identification of the device address such that image locations can be downloaded from the web site to the device.

If the user does wish to enter such configuration information, flow continues to block 604 in which the user enters the information. After the information is entered, the user is prompted to enter image locations. Again, where the display medium includes adequate user interface devices (e.g., computing device 102), this step may not be necessary in that these designations could be made with an application running on the display medium. Where the display medium comprises the display device 104, however, the locations normally are identified at the web site. As described above, the location can be identified by an address (e.g., URL) or some other path that will lead the display module 218, 316 to the location. The location information is received and stored, as indicated in block 608, and the display module 218, 316 retrieves the images that the user has identified with the location information, as indicated in block 610. Once the images are retrieved, they are displayed to the user, as indicated in block 612, for instance on a monitor of the computing device 102 or the display screen 105 of the display device 104. Later, if the user wishes to change the images displayed by the display medium, the user can again visit the web site and upload further images, remove images, or change the image location information in the manner described above. Accordingly, by simply changing the selections via the web site, the images displayed by the display media (one or more) can be automatically changed.

While particular embodiments of the invention have been disclosed in detail in the foregoing description and drawings for purposes of example, it will be understood by those skilled in the art that variations and modifications thereof can be made without departing from the scope of the invention as set forth in the following claims. For instance, although the invention is described in terms of displaying still images, it will be understood by persons having ordinary skill in the art that video could be provided to the display media in similar manner. In such a case, the video data could be displayed by another display device, such as a television, in the same manner as described above. Furthermore, the video data could, optionally, be recorded with an analog recording device such as a video cassette recorder (VCR), if desired.

What is claimed is:

1. A method for displaying images, comprising the steps of:
receiving image location information provided by a user;
retrieving an image through use of the image location information; and
displaying the retrieved image with a display medium.

2. The method of claim 1, wherein the image location information is received by a display module stored on the display medium.

3. The method of claim 1, wherein the image location information is received with a web site and transmitted from the web site to the display medium.

4. The method of claim 1, wherein the image location information comprises an address of an image repository.

5. The method of claim 1, wherein the image location information comprises an address of the image.

6. The method of claim 1, wherein the step of retrieving an image comprises the step of periodically retrieving an image and storing the image.

7. The method of claim 1, wherein the step of retrieving an image comprises the step of periodically retrieving an image and temporarily caching it to memory.

8. The method of claim 1, wherein the display medium is a desktop computing device.

9. The method of claim 1, wherein the display medium is a digital picture frame.

10. A system for displaying images, comprising:
means for receiving image location information provided by a user;
means for retrieving an image through use of the image location information; and
means for displaying the retrieved image with a display medium.

11. The system of claim 10, wherein the means for receiving image location information comprises a display module of the display medium.

12. The system of claim 10, wherein the means for receiving image location information comprises a web site that transmits the information to the display medium.

13. The system of claim 10, wherein the means for retrieving an image comprises means for retrieving the image from an image repository.

14. The system of claim 10, wherein the means for retrieving an image comprises means for retrieving the image directly.

15. The system of claim 10, further comprising means for storing the image.

16. A system for displaying images, comprising:
logic configured to receive image location information input from a user;
logic configured to retrieve an image based upon the image location information; and
logic configured to display the image on a display medium.

17. The system of claim 16, wherein the logic configured to receive image location information comprises a display module of the display medium.

18. The system of claim 16, wherein the logic configured to receive image location information comprises a web site that transmits the information to the display medium.

19. The system of claim 16, wherein the logic configured to retrieve an image comprises logic configured to retrieve the image from an image repository.

20. The system of claim 16, wherein the logic configured to retrieve an image comprises logic configured to retrieving the image directly.

21. The system of claim 16, further comprising logic configured to store the image.
